(19) United States
(12) Patent Application Publication
(10) Pub. No.: US 2013/0049275 A1
(43) Pub. Date: Feb. 28, 2013

(54) CUTTING BOARD

(71) Applicant: Phillip Morgan, Burnaby (CA)

(72) Inventor: Phillip Morgan, Burnaby (CA)

(73) Assignee: SPOS Specialty Products Online Store Ltd., Burnaby (CA)

(21) Appl. No.: 13/592,739

(22) Filed: Aug. 23, 2012

(30) Foreign Application Priority Data
Aug. 26, 2011 (CA) 2750966

(51) Int. Cl. A47J 47/00

(52) U.S. Cl. 269/14; 269/13; 269/15

(57) ABSTRACT

A cutting board for capturing and draining liquids from food items. Projection(s) extend from the bottom side of the board for supporting the board above a work surface. A drain port for draining liquid has an inlet in a channel defined on the top side of the board and an outlet below the bottom side of board and above the bottom(s) of the projection(s). The outlet is defined on an outlet portion configured for causing liquid from the outlet to collect away from the bottom(s) of the projection(s).

### REFERENCE TO RELATED APPLICATION

The application claims the benefit under 35 U.S.C. §119 of Canadian patent application No. 2,750,966 filed on 26 Aug. 2011 which is hereby incorporated herein by reference.

### TECHNICAL FIELD

The application relates to cutting boards. Some aspects of the invention provide a cutting board configured to cooperate with a drip tray, such that liquids expelled from foods cut or prepared on the cutting board are directed into the drip tray.

### BACKGROUND

Preparing (e.g., cutting, tearing, etc.) food typically causes liquid (e.g., juices, blood, etc.) to be expelled from the food. These liquids may be staining and/or difficult to clean up (e.g., because some such liquids are oily, sticky or the like). To prevent such liquids from spilling off of the cutting board, some cutting boards include a peripheral channel for trapping liquids. Some cutting boards are designed to be mounted over drip trays, and have ports through which liquid may drain to the drip tray.

A problem with known cutting boards having drain ports is that liquid tends to collect in drops on the underside of the board in the vicinity of the edges of the ports. Such drops may spread along the underside of the board (e.g., when the board is transported or inclined). Liquid spread across the underside of the board is associated with at least the following disadvantages:
the liquid will be transferred to surfaces on which the board is placed;
the underside of the board is made slippery by the liquid;
if the liquid is warm and the board is placed on a flat, smooth surface, the cooling liquid may result in a partial vacuum which adheres the board to the surface; and
after use, the liquid must be cleaned from the underside of the board and the supporting surface on which the board has been placed.

Patent literature describing technology in the general field of cutting boards includes:
U.S. Pat. No. 6,889,969, Diermeier titled “Cutting board with removable footings”;
U.S. Pat. No. 6,651,970, Scott titled “Multi-functional cutting board”;
U.S. Pat. No. 3,598,164, August titled “Cutting board with improved reservoir”
U.S. Pat. No. 4,907,789, Tice titled “Cutting board assembly”;
U.S. Pat. No. 5,644,976, Muchin et al. titled “Footed cooking utensil”;
U.S. Pat. No. 6,722,644, Prosser titled “Cutting board with drain holes and fitted channel”;
U.S. Pat. No. 6,536,753, Keener titled “Cutting board having channel”;
U.S. Pat. No. 7,252,255, Cornfield titled “Food preparation implement”;
U.S. Pat. No. 7,735,816, Hashim titled “Carve Smart”;
U.S. Pat. No. 1,745,805, Miller titled “Tray”; and
US200/50040580, Davis titled “Cutting board”.

There is a general desire for a cutting board which ameliorates, at least partially, disadvantages of known cutting boards. More particularly, there is a desire for a cutting board that, at least partially, does one or more of the following:
limits or prevents spilling of liquid across the perimeter edges of the top (cutting surface) of the cutting board (e.g., onto countertops, tables and the like on which the cutting board may be situated);
facilitates collection of liquid from the top of the cutting board in a vessel (e.g., a drip tray);
facilitates mounting of the cutting board over the vessel in which relative movement between the cutting board and the vessel is limited;
limits or prevents travel of liquid drained from the top of the cutting board along the underside of the board; and
minimizes or eliminates transfer of liquid to a supporting surface when the cutting board is placed on the supporting surface after use.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

An aspect of the invention provides a cutting board comprising a slab having a channel defined on a top side thereof, one or more projections extending from a bottom side of the slab, the one or more projections comprising a support portion and an outlet portion, and a drain port having an inlet communicating with the channel and an outlet defined at least partially on the outlet portion, the outlet located below the bottom side of the slab and above the support portion of the one or more projections. The outlet portion is configured for causing liquid from the outlet to collect away from the support portion. The cutting board may be configured to cooperate with a drip tray, so that when the board is mounted on the drip tray, liquids drain through the drain port into the drip tray.

In some embodiments, the outlet portion is sloped downwardly-away from the support portion. The outlet portion and the support portion may be located on the same one of the one or more projections, or on different ones of the one or more projections. In some embodiments, the one or more projections comprise one or more locating portions located inwardly adjacent to two sides of a rectangle, and the outlet is located inside the rectangle. The rectangle may correspond to an inward face of a sidewall of a cooperating drip tray, such that the locating portions are located inwardly adjacent to the sidewall of the drip tray when the cutting board is mounted on the drip tray.

Another aspect of the invention provides a cutting board comprising a generally rectangular slab having a channel defined on a top side thereof, four projections extending from a bottom side of the slab, the four projections inwardly spaced from respective corners of the slab, each projection comprising a support portion generally parallel to the slab, and an outlet portion below the bottom side of the slab and above the support portion, the outlet portion sloping downwardly away from the support portion, and a drain port having an inlet communicating with the channel and an outlet defined on one of the outlet portions. In some embodiments, the support portion is located inward of the outlet portion, and outlet portion slopes downwardly outward (or, equivalently, upwardly inward). In some such embodiments, the support portion provides an inward corner of the projection, and the outlet portion provides an outward corner of the projection and slopes upwardly inward from the outward corner.

A further aspect of the invention provides a cutting board comprising a slab having a channel defined on a top side thereof, one or more projections extending from a bottom side of the slab, the one or more projections comprising a support portion spaced apart from the bottom side of the slab, and a drain port having an inlet communicating with the channel and an outlet, the outlet located below the bottom of the slab and above the support portion. Every surface path from the outlet to the support portion may comprise a pair of vertically extending segments, a lower region of each vertically extending segment located below an upper region of the other vertically extending segment. In some embodiments, the outlet is defined on an outlet portion configured so that when the slab is horizontal liquid exiting the outlet runs away from the support portion. The outlet portion may provide one of the vertically-extending portions of every surface path from the outlet to the support portion.

Other aspects of the invention provide kits comprising drip trays and cutting boards mountable on the drip trays. For example, an aspect of the invention provides a kit comprising a drip tray having a sheet and a continuous sidewall extending around the periphery of the sheet, and a cutting board mountable on the drip tray comprising a slab having a channel defined on a top side thereof, one or more projections extending from a bottom side of the slab, the one or more projections comprising a support portion, an outlet portion and one or more locating portions located to be inwardly adjacent to the sidewall of the drip tray when the cutting board is mounted on the drip tray, and a drain port having an inlet communicating with the channel and an outlet defined at least partially on the outlet portion, the outlet below the bottom side of the slab, above the support portion and located to be inside the sidewall when the cutting board is mounted on the drip tray. The outlet portion may be configured for causing liquid from the outlet to collect away from the support portion. In some embodiments, the support portion is configured to be spaced apart from the sheet when the cutting board is mounted on the drip tray. The sheet may be rectangular and the one or more locating portions may comprise a pair of locating portions configured to be inwardly adjacent to opposite sides of the sidewall. In some embodiments, an outward face of the one or more locating portions has a slope matching a slope of a portion of the sidewall that is adjacent to the face when the cutting board is mounted on the drip tray.

In addition to the exemplary aspects and embodiments described above, further aspects and embodiments will become apparent by reference to the drawings and by study of the following detailed descriptions.

### BRIEF DESCRIPTION OF DRAWINGS

In drawings that show non-limiting example embodiments:

FIG. 1 shows a top perspective view of a kit comprising cutting board according to an example embodiment and a drip tray.

FIG. 2 shows a top plan view of the FIG. 1 cutting board.

FIG. 3 shows a bottom perspective view of the FIG. 1 cutting board.

FIG. 4 shows a bottom plan view of the FIG. 1 cutting board.

FIG. 5 shows a top perspective exploded view of a cutting board and drip tray assembly according to an example embodiment.

FIG. 6 shows a cross section view of the FIG. 5 cutting board and drip tray assembly.

FIG. 7 shows a cross section view of the FIG. 5 cutting board and drip tray assembly.

FIG. 8 shows a top perspective detail view of a projection of a cutting board according to an example embodiment.

FIG. 9 shows a bottom plan detail view of the FIG. 8 projection.

FIG. 10 shows a top plan detail view of the FIG. 8 projection.

FIG. 11 shows a cross-section detail view of the FIG. 8 projection.

FIG. 12 shows a partial cross section view of a cutting board and drip tray assembly according to an example embodiment.

FIG. 13 shows a partial bottom plan view of a cutting board according to an example embodiment.

FIG. 14 shows a partial bottom plan view of a cutting board according to an example embodiment.

FIG. 15 shows a partial bottom plan view of a cutting board according to an example embodiment.

FIG. 16 shows a partial bottom plan view of a cutting board according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

In the following description and claims, directional terms, such as “upper”, “lower”, “top”, “bottom”, “below”, “above”, “under”, “inward”, “outward” and the like, are used to describe example embodiments and features thereof. Such directional terms are used for purposes of clarity of expression only, and are not intended to be strictly limiting. It will be understood that such terms may be switched in uniform fashion.

Some embodiments provide a cutting board useful in combination with a drip tray, which may be used to reduce or eliminate the transfer of liquid across the underside of the board and/or to surfaces on which the board is placed. Some embodiments provide a cutting board for capturing and draining liquids expelled from food items prepared thereon.

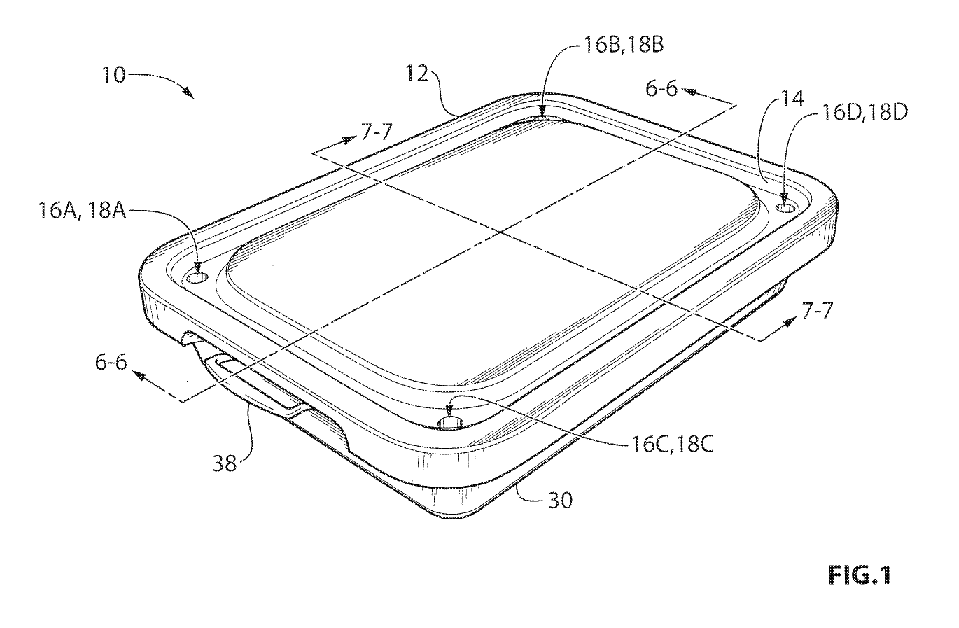

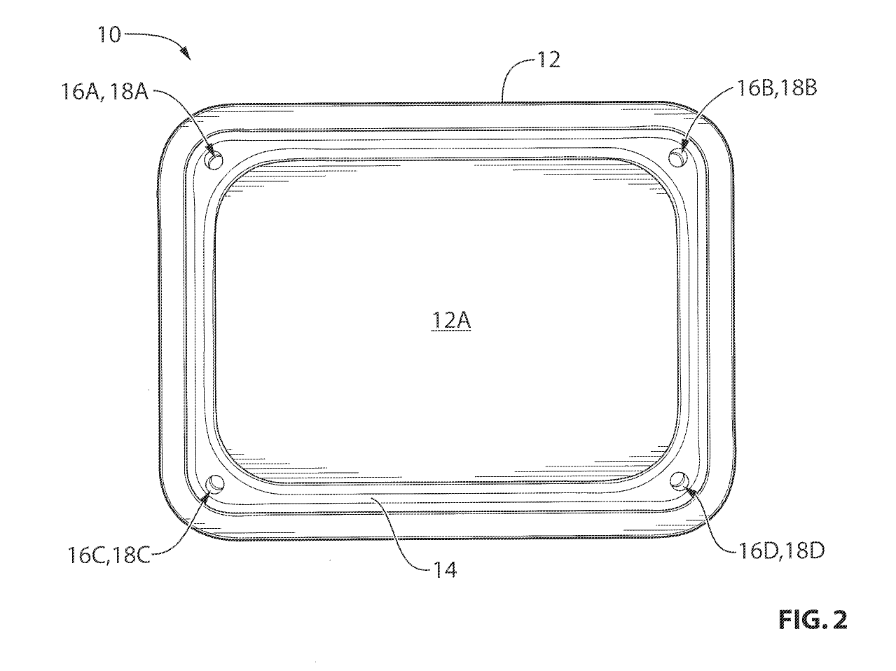

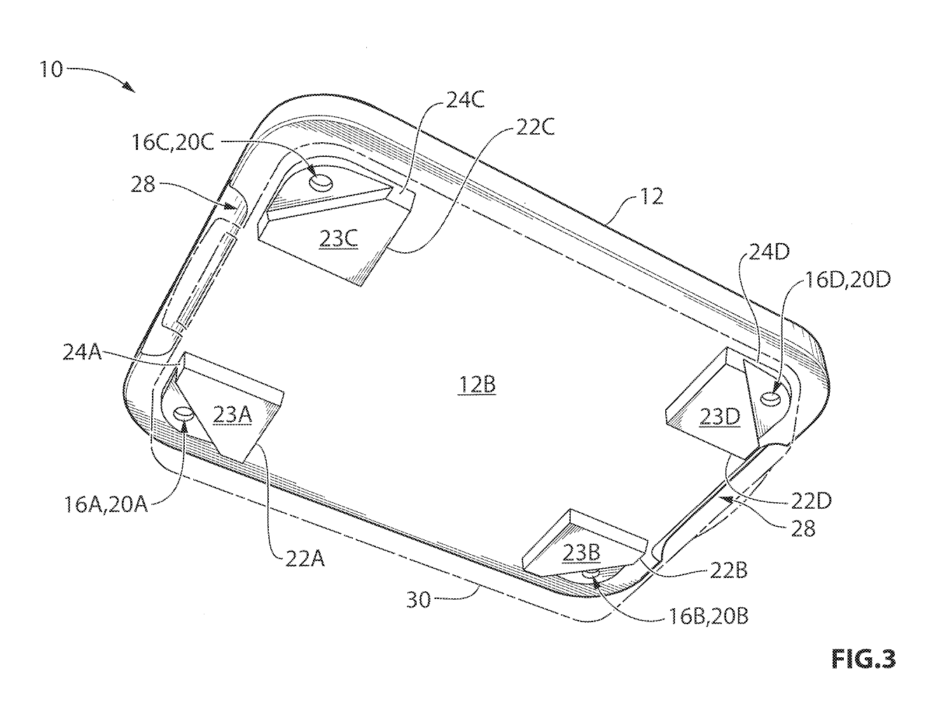

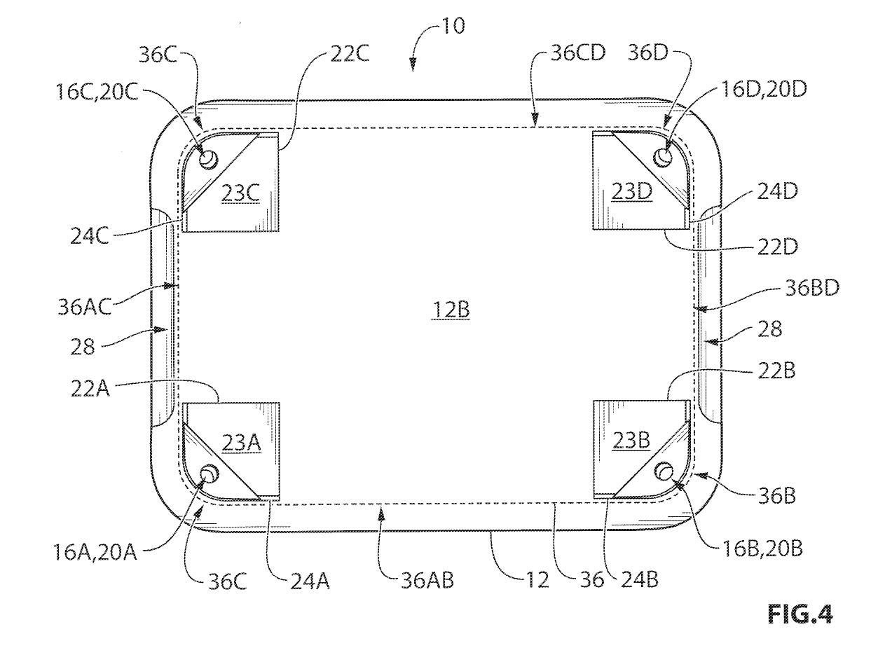

FIGS. 1 and 2 show, respectively, top perspective and top plan views of a cutting board 10 according to an example embodiment mounted on a drip tray 30 (drip tray 30 is not visible in FIG. 2). Board 10 comprises a generally planar rectangular slab 12. A concave, upwardly opening channel 14 is defined in the upper surface 12A of slab 12, adjacent the edges thereof. Channel 14 is continuous about the periphery of the upper surface of slab 12. A plurality (e.g., 4) drain ports 16A-D comprise inlets 18A-D, respectively, which communicate with channel 14 and a respective one of a plurality of outlets 20A-D (see FIGS. 3 and 4) located below slab 12. More particularly, drain ports 16A-D comprise bores defined in slab 12. Channel 14 may be sloped relative to the upper surface 12A of slab 12 along at least part of its length to encourage the flow of liquids in channel 14 toward one or more of drain ports 16A-D.

FIGS. 3 and 4 show, respectively, bottom perspective and bottom plan views of cutting board 10. In FIG. 3, drip tray 30 is shown in phantom. A plurality of projections 22A-D extend downwardly from the bottom side 12B of slab 12. Each of outlets 20A-D of drain ports 16A-D are located inwardly from the outer portions of projections 22A-D. More particularly, drain ports 16A-D comprise bores in projections 22A-D.

Projections 22A-D are configured to stably support board 10 in a generally horizontal configuration on a flat surface. More particularly, projections 22A-D comprise support portions 23A-D that are each spaced apart from the bottom side 12B of slab 12 by the same distance. Projections 22A-D may also be inwardly spaced from respective corners of slab 12. In some non-limiting example embodiments:
projections 22A-D are inwardly spaced from respective adjacent edges of slab 12 by at least ½ inch;
projections 22A-D are inwardly spaced from respective adjacent edges of slab 12 by not more than 1 inch; and/or
projections 22A-D are inwardly spaced from respective adjacent edges of slab 12 by approximately ¾ inch.

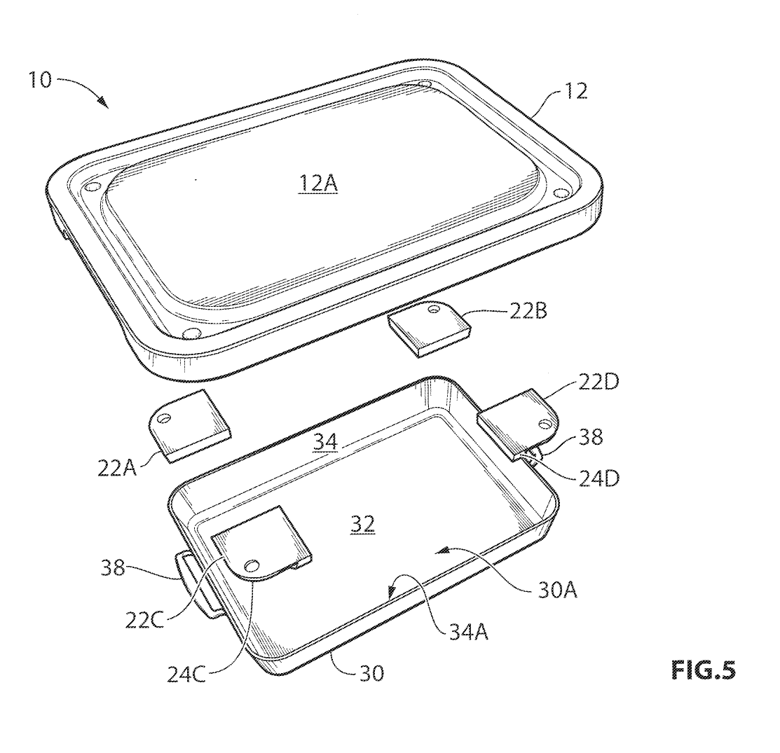

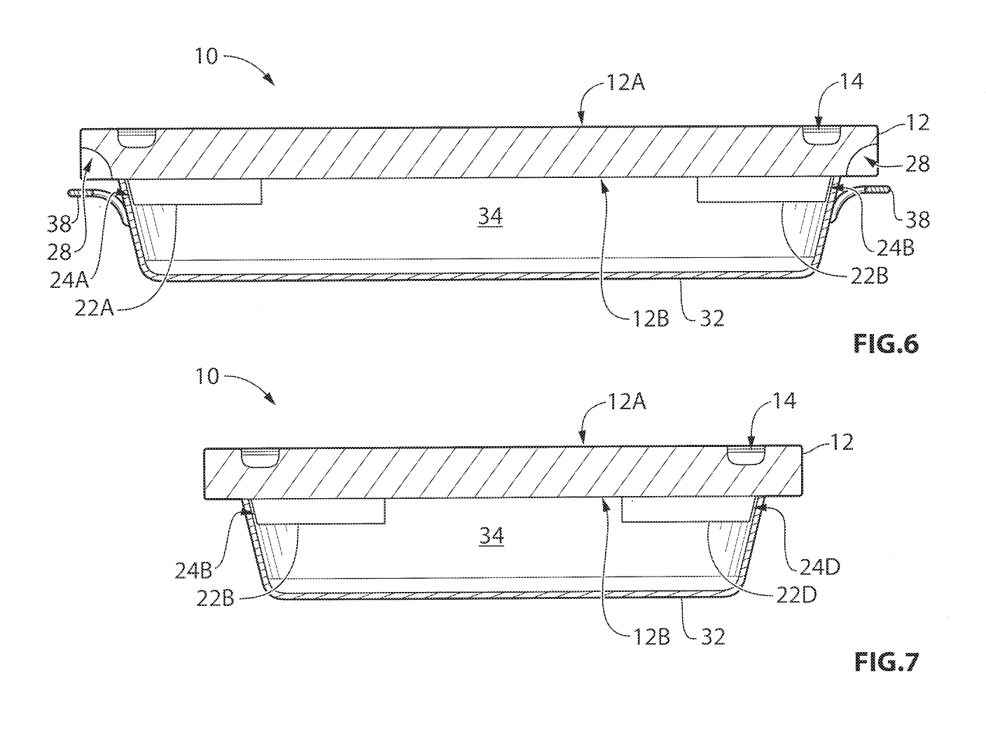

FIG. 5 shows an exploded top perspective view of cutting board 10 mounted on drip tray 30. FIGS. 6 and 7 show cross-sectional views of cutting board 10 mounted on drip tray 30. Drip tray 30 comprises a rectangular sheet 32 bordered by a continuous vertically extending sidewall 34 to define an upwardly opening concavity 30A. In the illustrated embodiment, sidewall 34 is steeply inclined upwardly outward, but in other embodiments is vertical. Drip tray 30 may comprise an All-Clad® Gourmet Ovenware® baking sheet or baker manufactured by All-Clad Metalcrafters LLC of Canonsburg, Pa., for example.

The distance between support portions 23A-D of projections 22A-D and the bottom side 12B of slab 12 (e.g., a height of projections 22A-D) is less than the upward extension of sidewall 34 from sheet 32 of drip tray 30 (e.g., the height of sidewall 34 of drip tray 30). As a consequence, support portions 23A-D of projections 22A-D are spaced apart from sheet 32 of drip tray 30 when cutting board 10 is mounted on drip tray 30. This may prevent support portions 23A-D of projections 22A-D from being wetted by liquid in drip tray 30 (e.g., liquid that has drained from the top side of cutting board 10 into tray 30) when cutting board 10 is mounted thereon. In some non-limiting example embodiments:
sidewall 34 has a height in a range of ⅞ inch to 2½ inches;
support portions 23A-D are spaced apart from sheet 32 by at least ¼ inch;
support portions 23A-D are spaced apart from sheet 32 by not more than ¾ inch;
support portions 23A-D are spaced apart from sheet 32 by approximately ½ inch;
support portions 23A-D are spaced apart from the bottom side 12B of slab 12 by at least ⅜ inch;
support portions 23A-D are spaced apart from the bottom side 12B of slab 12 by not more than ¾ inch; and/or
support portions 23A-D are spaced apart from the bottom side 12B of slab 12 by approximately ½ inch.

Projections 22A-D of the illustrated embodiment comprise locating portions 24A-D. Locating portions 24A-D may comprise the outward facing side faces of projections 22A-D. In the illustrated embodiment, each of projections 22A-D comprises a corresponding one of support portions 23A-D and a corresponding one of locating portions 24A-D. In other embodiments, a locating portion may be located on a projection that does not include a support portion, and vice versa. Locating portions 24A-D are configured to limit relative lateral movement between cutting board 10 and drip tray 30 when board 10 is mounted on drip tray 30. More particularly, locating portions 24A-D are configured to be inwardly adjacent (e.g., in or near abutment with) sidewall 34 of drip tray 30 when cutting board 10 is mounted on the drip tray (e.g., when the periphery of bottom side 12B of slab 12 is rested on the top of sidewall 34).

The configuration of locating portions 24A-D in this respect can be seen in FIG. 4, where locating portions 24A-D are shown inwardly adjacent to a notional rectangle 36 corresponding to sidewall 34 (more particularly, inward top edge 34A of sidewall 34). As shown in FIG. 4:
long-side adjacent faces of locating portions 24A and 24B are inwardly adjacent side 36AB of rectangle 36;
short-side adjacent faces of locating portions 24B and 24D are inwardly adjacent side 36BD of rectangle 36;
long-side adjacent faces of locating portions 24C and 24D are inwardly adjacent side 36CD of rectangle 36;
short-side adjacent faces of locating portions 24A and 24C are inwardly adjacent side 36AC of rectangle 36; and
locating portions 24A-D are inwardly adjacent corners 36A-D, respectively, of rectangle 36.

In some embodiments, locating portions 24A-D are configured to be spaced apart from their respective proximate sidewalls 34 of the tray 30 when cutting board 10 is mounted thereon by one or more of: at least 1/64 inch, at least 1/32 inch, not more than 1/16 inch, not more than ⅛ inch, not more than ¼ inch, approximately 1/32 inch and approximately 1/16 inch.

In a particular example embodiment where cutting board 10 is configured to cooperate with a drip tray comprising an All-Clad® Gourmet Ovenware® large shallow baker (nominally dimensioned 12 inches by 15 inches), the inward top edge of the sidewall of the baker defines a notional rectangle 36 measuring 12½ inches by 15⅞ inches, opposite long-side adjacent faces of locating portions 24A-D are spaced apart by 12 7/16 inches, and opposite short-side adjacent faces of locating portions 24A-D are spaced apart by 15 13/16 inches. In another particular example embodiment where cutting board 10 is configured to cooperate with an All-Clad® Gourmet Ovenware® small shallow baker (nominally dimensioned 9 inches by 13 inches), the inward top edge of the sidewall of the baker defines a notional rectangle 36 measuring 9⅛ inches by 13⅛ inches, opposite long-side adjacent faces of locating portions 24A-D are spaced apart by 9 1/16 inches, and opposite short-side adjacent faces of locating portions 24A-D are spaced apart by 13 1/16 inches.

Locating portions 24A-D of the illustrated embodiment are configured to facilitate mounting of cutting board 10 onto drip tray 30. More particularly, the locating portions 24A-D are sloped downwardly inward. As a consequence, when some of locating portions 24A-D ride downwardly on a portion of sidewall 34, cutting board 10 moves toward the center of drip tray 30, which may help in positioning others of locating portions 24A-D near sidewall 34. In some embodiments the slope of locating portions 24A-D is in the range of 5 degrees to 15 degrees from vertical. In some embodiments, the slope of locating portions 24A-D is approximately equal to the slope of sidewall 34.

Drip tray 30 comprises optional handles 38 that project outwardly from opposite faces of sidewall 34. Slab 12 is dimensioned so that the edges thereof proximate to handles 38 extend outward of sidewall 34, but not so far that handles 38 cannot be grasped when cutting board 10 is mounted on drip tray 30. As can be seen in FIGS. 3, 4 and 6, optional recesses 28 are defined on opposite edges of the bottom of slab 12 to provide a space between slab 12 and handles 38 when cutting board 10 is mounted on drip tray 30. Recesses 28 may be configured to provide sufficient space for lifting cutting board 10 on and off drip tray 30 (e.g., recesses 28 may be large enough to permit fingers to be inserted between slab 12 and the upper side of handles 38).

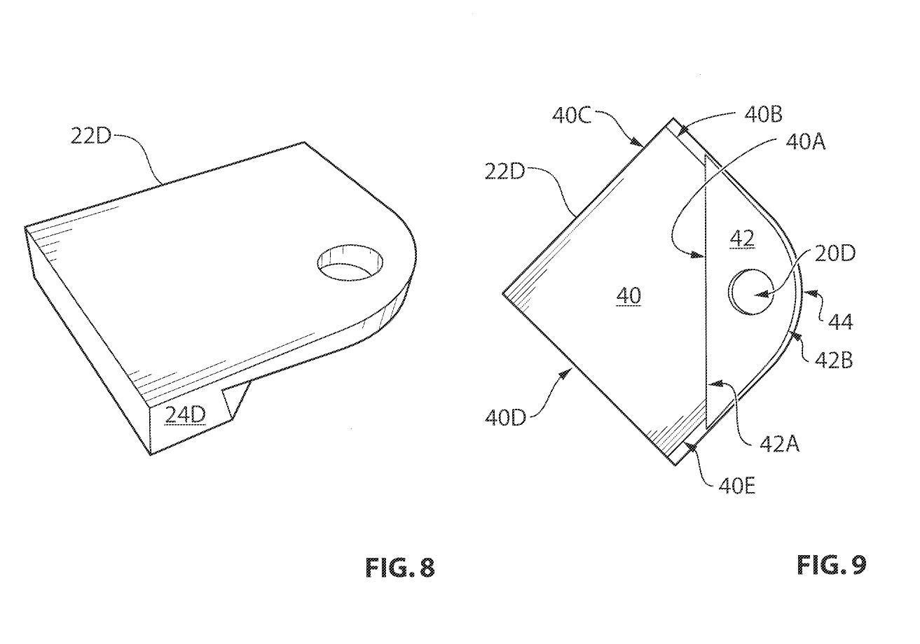

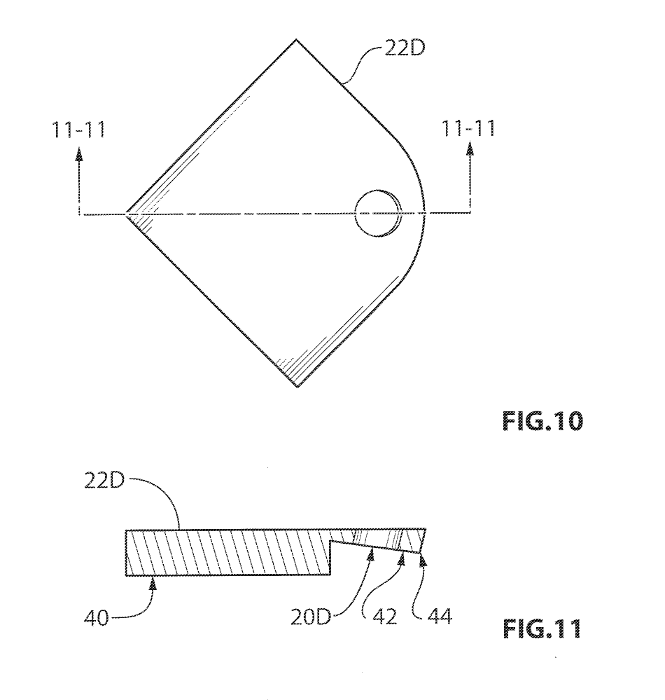

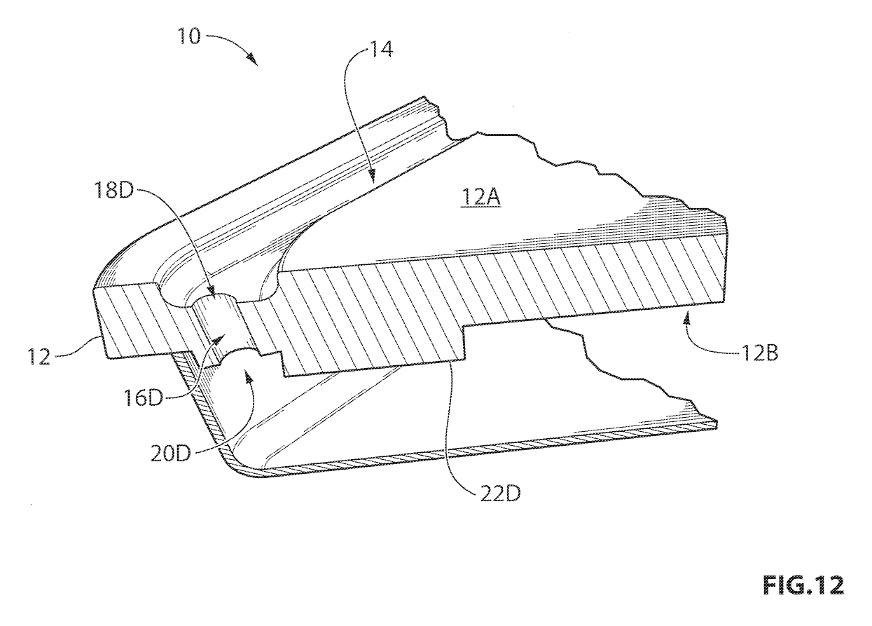

FIGS. 8, 9, 10 and 11 show, respectively, top perspective, bottom plan, top plan and cross-sectional views of projection 22D. FIG. 12 shows a cutaway cross-sectional view of the corner of cutting board 10 that includes projection 22D mounted on drip tray 30. Projection 22D has the same general configuration as projections 22A-C. Projection 22D comprises support portion 40 and outlet portion 42. Outlet 20D is defined on outlet portion 42.

In the illustrated embodiment, support portion 40 is provided by the bottom of projection 22D. Support portion 40 is generally parallel to and spaced apart from slab 12. Outlet portion 42 is located above support portion 40 (i.e., outlet portion 42 is closer to bottom side 12B of slab 12 than support portion 40). As a consequence, when support portion 40 is rested flat on a support surface, outlet portion 42 is upwardly spaced apart from the support surface (i.e., no part of outlet portion 42 contacts the support surface), and one corner of the cutting board is stably supported by the contact of support portion 40 with the support surface.

Outlet portion 42 may be configured so that liquid on outlet portion 42 collects away from support portion 40. More particularly, in the illustrated embodiment, outlet portion 42 is located outwardly of support portion 40 and outlet portion 42 slopes upwardly inward from its outward corner 44. Because outlet portion 42 is located outward of support portion 40, outlet portion 42 slopes downwardly away from support portion 40. As a consequence, when cutting board 10 is mounted on drip tray 30 (and also when support portion 40 is rested flat on a support surface), liquid on outlet portion 42 runs away from support portion 40. Since outlet portion 42 is located below the bottom side 12B of slab 12, liquid on outlet portion 42 also runs away from the bottom 12B side of slab 12.

In the illustrated embodiment, every surface path from outlet 20D to support portion 40, when traversed from outlet 20D to support portion 40, has at least one upwardly-sloped segment. In other words, no surface path from outlet 20D to support portion 40, when traversed from outlet 20D to support portion 40, has slope less than or equal to zero at every point along its length. As a result, liquid cannot run from outlet 20D to support portion 40 when cutting board 10 is horizontal or inclined to horizontal by less than a threshold incline. This functional result is a consequence of the structural configuration of outlet portion 42 and support portion 40.

In particular, outlet portion 42 and support portion 40 may be configured such that every surface path from outlet 20D to support portion 40 comprises a pair of vertically extending segments each having a lower region below the upper region of the other. This configuration may be explained in the context of the illustrated embodiment with reference to FIG. 9 as follows.
Because outlet 20D is located on outlet portion 42, which is defined by inward edge 42A and outward edge of 42B, every surface path from outlet 20D to support portion 40 must cross at least one of inward edge 42A and outward edge 42B.
Accordingly, every surface path from outlet 20D to support portion 40 comprises a first vertically extending segment that either:
   (1) has a lower region adjacent outlet 20D and an upper region that includes inward edge 42A, or
   (2) has a lower region that includes outward edge 42B and an upper region adjacent outlet 20D.
Because support portion 40 is defined by edges 40A, 40B, 40C, 40D, and 40E, every surface path from outlet 20D to support portion 40 must cross at least one of these edges.
Since each of edges 40A-40E is an edge of a vertically extending face whose opposite edge lies either along inward edge 42A of outlet portion 42 or the bottom side of slab 12, every surface path from outlet 20D to support portion 40 comprises a second vertically extending segment having:
   (1) a lower region that includes one of edges 40A-E and
   (2) an upper region that is adjacent either inward edge 42A or the bottom side of slab 12.
The lower regions of all first vertically extending segments (outlet 20D and outward edge 42B) are lower than the upper regions of all second vertically extending portions (the bottom side of slab 12 and inward edge 42A).
The lower regions of all second vertically extending segments (edges 40A-E) are lower than the upper regions of all first vertically extending portions (outlet 20D and inward edge 42A).

As stated above, liquid cannot run from outlet 20D to support portion 40 while cutting board 10 is horizontal or inclined to horizontal by less than a threshold incline. In the illustrated embodiment, the upward slope of outlet portion 42 from outlet 20D to inward edge 42A prevents liquid from flowing from outlet 20D to support portion 40, and the threshold incline is approximately equal to the slope of outlet portion 42.

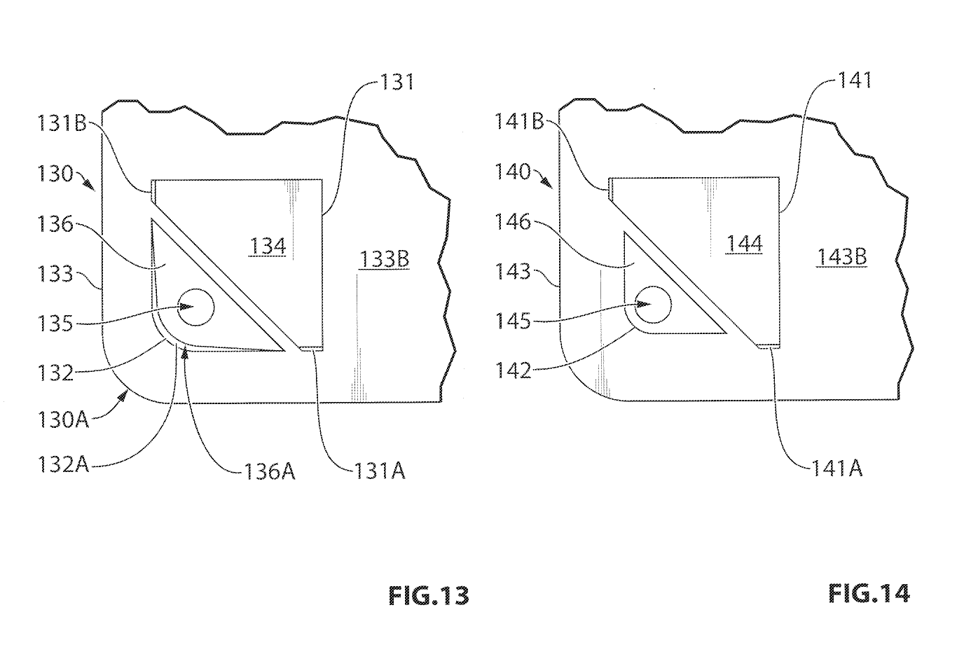

FIGS. 13, 14, 15 and 16 show partial bottom plan views of cutting boards 130, 140 and 150 and 160 according to other example embodiments, respectively. Cutting boards 130, 140 and 150 and 160 are generally similar to cutting board 10, but differ in the configuration of their projections, support portions, locating portions, and/or outlet portions. Configuration of projections, support portions, locating portions, and/or outlet portions shown in FIGS. 13-16 may be used at other locations on cutting boards (e.g., with mirror symmetry at corners not shown in the partial views of FIGS. 13-16).

In FIG. 13, a first projection 131 and a second projection 132 extend from the bottom side 133B of slab 133 of cutting board 130. First projection 131 and second projection 132 are spaced apart from one another. Support portion 134, which provides the bottom of first projection 131, is spaced apart from bottom side 133B of slab 133. Outlet 135 is defined on outlet portion 136, which provides the bottom of second projection 132. Outlet portion 136 is spaced apart from the bottom side 133B of slab 133 and slopes downwardly outward (i.e., out of the page of FIG. 13 and generally toward corner 130A of cutting board 130). Outlet portion 136 is closer to the bottom side 133B of slab 133 than support portion 134.

It will be appreciated that outlet portion 136 and support portion 134 are configured such that every surface path from outlet 135 to support portion 134 comprises a pair of vertically extending segments, and that the lower region of each vertically extending segment is below the upper region of the other vertically extending segment. It will be further appreciated that outlet portion 136 is configured so that liquid on outlet portion 136 collects away from the support portion 134 (i.e., on outward edge 136A of outlet portion 136).

In board 130, both first projection 131 and second projection 132 comprise, on their outward side faces, locating portions, namely locating portions 131A and 131B and locating portion 132A, respectively. In the illustrated embodiment, locating portions 131A, 131B and 132A are sloped downwardly inward.

In FIG. 14, a first projection 141 and a second projection 142 extend from the bottom side 143B of slab 143 of cutting board 140. First projection 141 and second projection 142 are spaced apart from one another. Support portion 144, which provides the bottom of first projection 141, is spaced apart from the bottom side 143B of slab 143. Outlet 145 is defined on outlet portion 146, which provides the bottom of second projection 142. Second projection 142 has vertical sidewalls (not visible in FIG. 14). Outlet portion 146 is spaced apart from and generally parallel to the side of slab 143. Outlet portion 146 is closer to the bottom side 143B of slab 143 than support portion 144.

It will be appreciated that outlet portion 146 and support portion 144 are configured such that every surface path from outlet 145 to support portion 144 comprises a pair of vertically extending segments, and that the lower region of each vertically extending segment is below the upper region of the other vertically extending segment. It will be further appreciated that outlet portion 146 is configured so that liquid on outlet portion 146 collects away from the support portion 144 (i.e., inside the edges of outlet portion 146).

In board 140, first projection 141 comprises, on its outward side faces, locating portions 141A and 141B. Locating portions 141A and 141B are located outward of second projection 142 (i.e., locating portions 141A and 141B are nearer to their respective proximate edges of slab 143 than any part of second projection 142). In the illustrated embodiment, locating portions 141A and 141B are sloped downwardly inward.

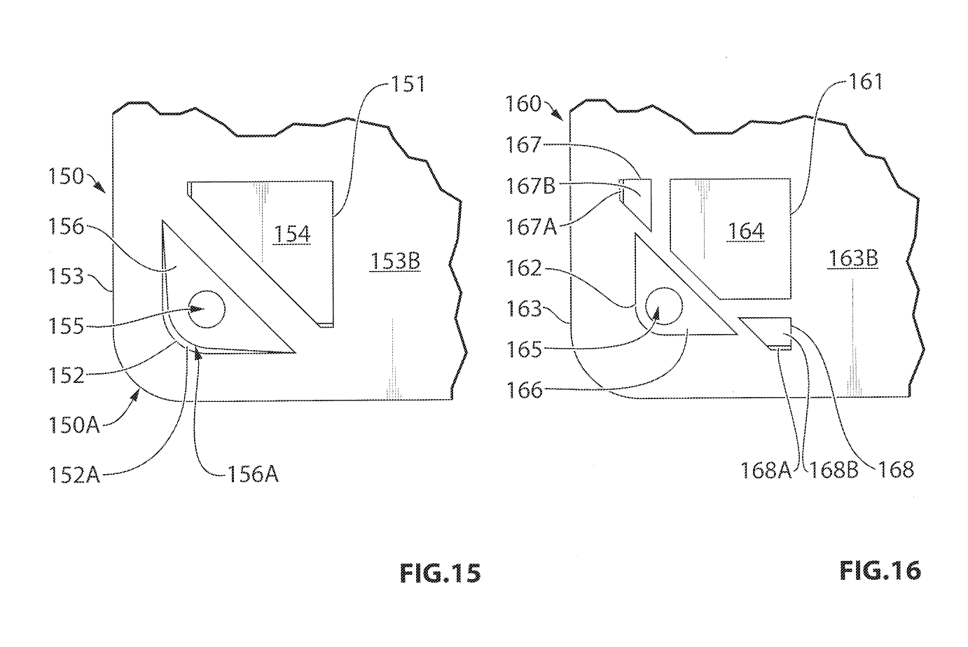

In FIG. 15, a first projection 151 and a second projection 152 extend from the bottom side 153B of slab 153 of cutting board 150. First projection 151 and second projection 152 are spaced apart from one another. Support portion 154, which provides the bottom of first projection 151, is spaced apart from the bottom of slab 153. Outlet 155 is defined on outlet portion 156, which provides the bottom of second projection 152. Outlet portion 156 is spaced apart from the bottom of slab 153 and slopes downwardly outward (i.e., out of the page of FIG. 15 and generally toward corner 150A of cutting board 150). Outlet portion 156 is closer to the bottom side 153B of slab 153 than support portion 154.

It will be appreciated that outlet portion 156 and support portion 154 are configured such that every surface path from outlet 155 to support portion 154 comprises a pair of vertically extending segments, and that the lower region of each vertically extending segment is below the upper region of the other vertically extending segment. It will be further appreciated that outlet portion 156 is configured so that liquid on outlet portion 156 collects away from the support portion 154 (i.e., on outward edge 156A of outlet portion 156).

In board 150, second projection 152 comprises, on its outward side face, locating portion 152A. Locating portion 152A is located outward of first projection 151 (i.e., locating portion 152A is nearer to its proximate edge of slab 153 than any part of first projection 151). In the illustrated embodiment, locating portion 152A is sloped downwardly inward.

In FIG. 16, a first projection 161 and a second projection 162 extend from the bottom side 163B of slab 163 of cutting board 160. First projection 161 and second projection 162 are spaced apart from one another. Support portion 164, which provides the bottom of first projection 161, is spaced apart from the bottom of slab 163. Outlet 165 is defined on outlet portion 166, which provides the bottom of second projection 162. Second projection 162 has vertical sidewalls (not visible in FIG. 16). Outlet portion 166 is spaced apart from and generally parallel to the bottom of slab 163. Outlet portion 166 is closer to the bottom side 163B of slab 163 than support portion 164.

It will be appreciated that outlet portion 166 and support portion 164 are configured such that every surface path from outlet 165 to support portion 164 comprises a pair of vertically extending segments, and that the lower region of each vertically extending segment is below the upper region of the other vertically extending segment. It will be further appreciated that outlet portion 166 is configured so that liquid on outlet portion 166 collects away from the support portion 164 (i.e., inside the edges of outlet portion 166).

Board 160 also comprises third projection 167 and fourth projection 168, which extend downwardly from the bottom of slab 163. The bottoms 167B and 168B of projections 167 and 168 are closer to the bottom side 163B of slab 163 than support portion 164. In other words, third projection 167 and fourth projection 168 are shorter than first projection 161. Locating portions 167A and 168A are located on outward side faces of third projection 167 and fourth projection 168, respectively. Locating portions 167A and 168A are located outward of first projection 161 and second projection 162 (i.e., locating portions 167A and 168A are nearer to their respective proximate edges of slab 163 than any part of first projection 161 and second projection 162). In the illustrated embodiment, locating portions 167A and 168A are sloped downwardly inward.

Cutting boards according to embodiments may be made out of a variety of materials, including for example, wood, plastics, metal, stone, combinations thereof and the like. Preferably, cutting boards according to embodiments are made of a material which is durable, easily cleaned, and suitable for contact with cooked or uncooked food that may be either hot or cold. Cutting boards according to embodiments of the invention may be formed from a single block of material (e.g., may be carved from a block of wood or stone, molded as a single piece of plastic or other moldable material, machined from a block of metal, etc.), or may be made from various assembled pieces (e.g., planks of wood glued together to form a slab, combinations of different materials, etc.).

Cutting boards according to embodiments may have shapes other than rectangles, such as circles, ovals, other curvilinear shapes, other polygon shapes or irregular shapes. In some embodiments, a cutting board is configured to fit a cooperating drip tray (e.g., projections may be configured to have locating portions which are located inwardly adjacent to sidewalls of a particular drip tray when the cutting board is mounted on the drip tray). It is not necessary that a cooperating cutting board and drip tray have the same shape (e.g., an oval cutting board may be configured to cooperate with a rectangular drip tray). Cutting boards according to embodiments need not be symmetric or regular in shape.

Some embodiments are configured for use with standard-sized ovenware. In some embodiments, projections comprise locating portions configured to be inwardly adjacent sidewalls of common baking sheets, bakers and/or roasting pans. For example:
projections may comprise locating portions configured to be inwardly adjacent to sidewalls of common nominal sizes of rectangular baking sheets, bakers and/or roasting pans, such as 14 inches by 17 inches, 10 inches by 14 inches, 9 inches×13 inches, 12 inches by 15 inches, 13 inches×18 inches, 21 inches by 15 inches, 18 inches by 26 inches, 12.5 inches by 17.5 inches, for example; and
projections may comprise locating portions configured to be inwardly adjacent to sidewalls of common nominal sizes of circular baking sheets, bakers and/or roasting pans, such as 9 inches, 10 inches, 12 inches or 14 inches, for example.

In some embodiments, projections comprise support portions configured to be spaced apart from sheet portions of standard-sized baking sheets, bakers and/or pans. For example, projections may be dimensioned so that the support portions thereof are spaced apart from the bottom portions of a cooperating baking sheet, baker or pan by at least ½ inch.

Some embodiments provide a kit comprising a drip tray and cutting board configured to cooperate therewith, as described herein.

Where a component (e.g. a projection, drain port, inlet, outlet, outlet projection, locating portion, support portion, outlet portion, slab, channel, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Where reference is made herein to a particular geometric shape having vertices, it is intended that such references are to be construed as including shapes in which one or more vertices are rounded (e.g., reference to a “rectangle” is intended to include both right-angle cornered rectangles and round cornered rectangles). Where the context permits, words in the above description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of example embodiments is not intended to be exhaustive or to limit this disclosure and claims to the precise forms disclosed above. While specific examples of, and examples for, embodiments are described above for illustrative purposes, various equivalent modifications are possible within the scope of the technology, as those skilled in the relevant art will recognize.

These and other changes can be made to the system in light of the above description. While the above description describes certain examples of the technology, and describes the best mode contemplated, no matter how detailed the above appears in text, the technology can be practiced in many ways. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific examples disclosed in the specification, unless the above description section explicitly and restrictively defines such terms. Accordingly, the actual scope of the technology encompasses not only the disclosed examples, but also all equivalent ways of practicing or implementing the technology under the claims.

From the foregoing, it will be appreciated that specific examples of apparatus and methods have been described herein for purposes of illustration, but that various modifications, alterations, additions and permutations may be made without departing from the practice of the invention. The embodiments described herein are only examples. Those skilled in the art will appreciate that certain features of embodiments described herein may be used in combination with features of other embodiments described herein, and that embodiments described herein may be practiced or implemented without all of the features ascribed to them herein. Such variations on described embodiments that would be apparent to the skilled addressee, including variations comprising mixing and matching of features from different embodiments, are within the scope of this invention.

As will be apparent to those skilled in the art in light of the foregoing disclosure, many alterations and modifications are possible in the practice of this invention without departing from the spirit or scope thereof. For example:
A cutting board may be mounted on a drip tray by resting less than the entire periphery of the cutting board's slab on the top of the sidewall. For example, in some embodiments a cutting board may be mounted on a drip tray by resting opposite edge portions of a cutting board's slab on opposite sidewall portions of the drip tray, while one or more other edge portions of the slab do not rest on the sidewall of the drip tray (e.g., in the manner of a square cutting board mounted on a rectangular drip tray).
An outlet of a drain port may be located, at least partially, on a face of a projection that meets the bottom side of a cutting board's slab (e.g., an outlet may straddle an edge between the face of the projection and the bottom side of the slab).
An outlet of a drain port may be defined on more than one face of a projection (e.g., an outlet may straddle an edge between two side faces, between a side face and a bottom face, between a two side faces and a bottom face, etc.).
Projections may comprise studs having any of a variety of shapes, such as rectangular blocks, square blocks, cylinders, conical frustums, semi-spheres, truncated triangular prisms, and the like.
Faces and/or edges of projections may be rounded, curved and/or smooth.
Projections may be formed integrally with a slab (e.g., integrally with one or more planks joined to form the slab, etc.) or may be joined to the slab (e.g., using adhesive, mechanical joining, combinations thereof, or the like).
Different numbers of projections may be provided to stably support a slab (e.g., a single endless projection may be provided adjacent the peripheral edge of a slab, a single centrally-located projection may be provided at the center of a slab, two elongate projections may be provided along opposite sides of a rectangular slab, three studs may be distributed about the perimeter of a circular slab, etc.).
Outlet portions and support portions need not be generally co-located (e.g., a single support portion may be provided on a centrally-located projection and one or more outlet portions may be provided on corresponding peripherally-located projections, a plurality of support portions may be provided on corresponding projections located at respective corners of a slab and one or more outlet portions may be provided on corresponding projections located between the corners of the slab).
Drain ports need not be located at corners of channels, and may be located anywhere along a channel.
Different numbers of drain ports may be provided (e.g., as few as one drain port may be provided, or more than four drain ports may be provided).
More than one channel may be provided.
Slabs need not be flat, and may be inclined, crowned, grooved or otherwise patterned.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their scope.

What is claimed is:

1. A cutting board comprising:
a slab having a channel defined on a top side thereof;
one or more projections extending from a bottom side of the slab, the one or more projections comprising a support portion and an outlet portion; and
a drain port having an inlet communicating with the channel and an outlet defined at least partially on the outlet portion, the outlet below the bottom side of the slab and above the support portion of the one or more projections,
wherein the outlet portion is configured for causing liquid from the outlet to collect away from the support portion.

2. The cutting board of claim 1 wherein the outlet portion is sloped downwardly-away from the support portion.

3. The cutting board of claim 1 wherein the outlet portion and the support portion are located on the same one of the one or more projections.

4. The cutting board of claim 1 wherein the outlet portion and the support portion are located on different ones of the one or more projections.

5. The cutting board of claim 1 wherein the one or more projections comprise one or more locating portions located inwardly adjacent to two sides of a rectangle and wherein the outlet is located inside the rectangle.

6. The cutting board of claim 5 wherein at least one of the one or more locating portions is inwardly adjacent to two adjacent sides of the rectangle that define a corner of the rectangle.

7. The cutting board of claim 5 wherein the one or more locating portions comprise four locating portions, each locating portion inwardly adjacent to two adjacent sides of the rectangle that define respective corners of the rectangle.

8. The cutting board of claim 5 wherein the rectangle measures 12½ inches by 15⅞ inches.

9. The cutting board of claim 5 wherein the rectangle measures 9⅛ inches by 12½ inches.

10. The cutting board of claim 1 wherein the one or more projections comprise one or more locating portions located inwardly adjacent to a circle and wherein the outlet is located inside the circle.

11. The cutting board of claim 10 wherein the one or more locating portions comprise three locating portions substantially equally distributed about the circle.

12. The cutting board of claim 5 wherein at least one of the one or more locating portions comprises an outward face that is at least partially downwardly inward sloped.

13. The cutting board of claim 3 wherein at least one of the one or more locating portions and the outlet portion are located on the same one of the one or more projections.

14. The cutting board of claim 3 wherein at least one of the one or more locating portions and the outlet portion are located on different ones of the one or more projections.

15. The cutting board of claim 3 wherein at least one of the one or more locating portions and the support portion are located on the same one of the one or more projections.

16. The cutting board of claim 3 wherein at least one of the one or more location portions and the support portion are located on different ones of the one or more projections.

17. The cutting board of claim 1 wherein the channel is downwardly sloped toward the inlet along at least part of its length.

18. The cutting board of claim 1 wherein the channel is adjacent a peripheral edge of the top side of the slab.

19. The cutting board of claim 1 wherein the channel is continuous around the peripheral edge of the top side of the slab.

20. A kit comprising:
a drip tray having a sheet and a continuous sidewall extending around the periphery of the sheet; and
a cutting board according to claim 5 mountable on the drip tray, wherein the rectangle corresponds to the sidewall of the drip tray.

21. The kit according to claim 20 wherein the support portion is configured to be spaced apart from the sheet when the cutting board is mounted on the drip tray.

22. The kit according to claim 20 wherein the one or more locating portions comprise a pair of locating portions configured to be inwardly adjacent to opposite sides of the rectangle.

23. The kit according to claim 20 wherein an outward face of the one or more locating portions has a slope matching a slope of a portion of the sidewall that is adjacent to the face when the cutting board is mounted on the drip tray.

24. A kit comprising:
a drip tray having a sheet and a continuous sidewall extending around the periphery of the sheet; and
a cutting board according to claim 1 mountable on the drip tray, wherein the outlet is located to be inside the sidewall when the cutting board is mounted on the drip tray, and wherein the one or more projections of the cutting board comprise one or more locating portions located to be inwardly adjacent to the sidewall of the drip tray when the cutting board is mounted on the drip tray.

25. The kit according to claim 24 wherein the support portion is configured to be spaced apart from the sheet when the cutting board is mounted on the drip tray.

26. The kit according to claim 24 wherein the sidewall is rectangular and wherein the one or more locating portions comprise a pair of locating portions configured to be inwardly adjacent to opposite sides of the sidewall.

27. The kit according to claim 24 wherein an outward face of the one or more locating portions has slope matching the slope of a portion of the sidewall that is adjacent to the face when the cutting board is mounted on the drip tray.

28. A kit comprising:
a drip tray having a sheet and a continuous sidewall extending around the periphery of the sheet; and
a cutting board mountable on the drip tray comprising:
a slab having a channel defined on a top side thereof;
one or more projections extending from a bottom side of the slab, the one or more projections comprising a support portion, an outlet portion and one or more locating portions located to be inwardly adjacent to the sidewall of the drip tray when the cutting board is mounted on the drip tray, and
a drain port having an inlet communicating with the channel and an outlet defined at least partially on the outlet portion, the outlet below the bottom side of the slab, above the support portion and located to be inside the sidewall when the cutting board is mounted on the drip tray,
wherein the outlet portion is configured for causing liquid from the outlet to collect away from the support portion.

29. A cutting board comprising:
a generally rectangular slab having a channel defined on a top side thereof;
four projections extending from a bottom side of the slab, the four projections inwardly spaced from respective corners of the slab, each projection comprising:
a support portion generally parallel to the slab, and
an outlet portion below the bottom side of the slab and above the support portion, the outlet portion sloping upwardly inward from an outward corner of the projection; and
a drain port having an inlet communicating with the channel and an outlet defined on one of the outlet portions.

30. A cutting board comprising:
a slab having a channel defined on a top side thereof;
one or more projections extending from a bottom side of the slab, the one or more projections comprising a support portion spaced apart from the bottom side of the slab; and
a drain port having an inlet communicating with the channel and an outlet, the outlet located below the bottom of the slab and above the support portion,
wherein every surface path from the outlet to the support portion comprises a pair of vertically extending segments, a lower region of each vertically extending segment below an upper region of the other vertically extending segment.

31. The cutting board of claim 30 wherein the outlet is defined on an outlet portion configured so that when the slab is horizontal liquid exiting the outlet runs away from the support portion.

32. The cutting board of claim 31 wherein the outlet portion provides one of the vertically-extending portions of every surface path from the outlet to the support portion.
